(19) United States
(12) Patent Application Publication
(10) Pub. No.: US 2010/0118283 A1
(43) Pub. Date: May 13, 2010

(54) LIGHT SOURCE UNIT AND IMAGE DISPLAYING APPARATUS USING THE SAME

(75) Inventors: Jyunichi AIZAWA, Tokyo (JP); Yukio Sato, Tokyo (JP); Mitoru Yabe, Tokyo (JP); Hiroshi Sasaki, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 12/560,995

(22) Filed: Sep. 16, 2009

(30) Foreign Application Priority Data
Sep. 19, 2008 (JP) 2008-240610

(51) Int. Cl. G03B 21/20; G02B 27/20

(52) U.S. Cl. 353/100; 362/259

(57) ABSTRACT

An object is to provide a light source unit that focuses a laser beam, having different divergence angles in longitudinal direction and lateral direction, so as not to allow longitudinally and laterally deviating from an incident end-face of an optical fiber. The light source unit herein provided is configured to form the laser beam 9 emitted from a laser element 7, having different divergence angles in longitudinal direction and lateral direction, into a parallel-ray laser beam by collimating laser beam rays in a plane in which the beam has a larger divergence angle using cylindrical lenses 10 and 11 in a first lens barrel 1 and also by collimating laser beam rays in a plane in which the beam has a smaller divergence angle using a cylindrical lens 12 therein, and to focus the parallel-ray laser beam onto the entrance of the optical fiber 3 using circular lenses 13 and 14 in a second lens barrel 2, whereby the first lens barrel 1 and the second lens barrel 2 are regularly positioned and directly coupled so that their optical axes coincide with each other.

### TECHNICAL FIELD

The present invention relates to light source units for use in a laser device requiring a laser beam transferred through an optical fiber, for example, a projector or a rear projection television in which images are projected onto a screen using the laser beam as a light source, or in a liquid-crystal television using it as a backlight.

### BACKGROUND ART

In a conventional light source unit, a collimation lens is used for forming a laser beam emitted from a semiconductor laser into a parallel-ray light beam, which is afterward focused by a plano-convex lens to obtain a light beam having a band-like cross-section. And then, the collimation lens and the plano-convex lens are held by separate lens barrels, and the two lens barrels are further held by their outer supporting part (for example, refer to Japanese Patent Application Publication No. H05-93881, Paragraphs 0024, 0032, FIG. 2). In addition, in another example, a laser beam emitted from a laser-diode (LD) chip having predetermined divergence angles is changed into a parallel-ray light beam by a collimation lens (convex lens), and is subsequently focused onto the front end of an optical fiber by a light-focusing or condenser lens (convex lens). And then, the collimation lens and the condenser lens are individually positioned and held in different lens holders (for example, refer to Japanese Patent Application Publication No. 2000-121888, Paragraphs 0018, 0019, FIG. 1). Moreover, in another example, after having collimated emission light from laser elements by collimation lenses each into a parallel-ray laser beam, focusing onto the front end of an optical fiber is performed using two pieces of light-focusing or condenser lenses (a cylindrical lens and an anamorphic lens). Note that, the two condenser lenses are together held in a condenser lens holder (for example, refer to Japanese Patent Application Publication No. 2007-67271, Paragraphs 0023, 0024, 0038, FIG. 2).

### Problems to be Solved by the Invention

In such light source units disclosed in Japanese Patent Application Publication No. H05-93881 and in Japanese Patent Application Publication No. 2000-121888, a cylindrical lens is not used, so that it is difficult to form a laser beam whose longitudinal and lateral divergence angles are different with each other, into a parallel-ray laser beam, and even when a laser beam is focused by using a light-focusing or condenser lens, after it has passed through a collimation lens, focusing onto an incident end-face of an optical fiber cannot be achieved. In a light source unit in Japanese Patent Application Publication No. 2007-67271, collimation lenses are used to form laser beams into a parallel-ray laser beam, so that it is difficult to form the laser beams having different divergence angles in longitudinal direction and lateral direction, into a parallel-ray laser beam. In addition, as to the light source unit in Japanese Patent Application Publication No. 2007-67271, a cylindrical lens is used; however, it is used for a condensing optical system, and a special anamorphic lens is also used to focus laser beams onto the front end of an optical fiber.

Moreover, in the light source unit in Japanese Patent Application Publication No. H05-93881, the collimation lens and the plano-convex lens are held by separate lens barrels, and these lens barrels are individually mounted on the supporting part, so that it is difficult to accurately make the optical axes of these two pieces of lenses coincide with each other. In addition, in the light source unit in Japanese Patent Application Publication No. 2000-121888, a lens barrel that holds the collimation lens and a lens barrel that holds a condenser lens are directly coupled; however, the two lens barrels are not positioned with each other, so that it is difficult to accurately make the optical axes coincide with each other. Moreover, in the light source unit in Japanese Patent Application Publication No. 2007-67271, the condenser lens holder is coupled with a laser unit that holds collimation lenses by way of an interconnecting member, so that there is such a problem that positioning of the condenser lenses and the collimation lenses is difficult.

The present invention has been directed at solving those problems described above, and an object of the invention is to focus, without using extra components such as a special lens like an anamorphic lens or a supporting stage other than lens barrels, a laser beam emitted from a laser element, having different divergence angles in longitudinal direction and lateral direction, so as not to allow longitudinally and laterally deviating from an incident end-face of an optical fiber.

### SUMMARY OF THE INVENTION

### Means for Solving the Problems

A light source unit according to the present invention comprises a laser element for emitting a laser beam having different divergence angles in longitudinal direction and lateral direction; at least one cylindrical lens placed with its generatrix perpendicular to an optical axis of the laser beam for forming the laser beam into a parallel-ray laser beam; a first lens barrel for holding the at least one cylindrical lens; a condenser lens placed downstream of the at least one cylindrical lens for focusing the parallel-ray laser beam; and a second lens barrel for holding the condenser lens; wherein the first lens barrel and the second lens barrel are positioned and coupled with each other so that an optical axis of the at least one cylindrical lens coincides with an optical axis of the condenser lens.

### Effects of the Invention

According to the present invention, a laser beam emitted from a laser element having different divergence angles in longitudinal direction and lateral direction is refracted by at least one cylindrical lens so as to form the beam into a longitudinally and laterally parallel-ray laser beam, and therefore, the laser beam can be focused into a smaller spot diameter when focusing is performed by a condenser lens after having the beam passed through the cylindrical lens. In addition, the at least one cylindrical lens and the condenser lens are held by separate lens barrels, so that it becomes possible to adopt the shape of the lens barrels that are individually made suitable for the cylindrical lens and the condenser lens.

Moreover, a lens barrel that holds the cylindrical lens and a lens barrel that holds a condenser lens are regularly positioned and coupled with each other, so that such effects can be obtained in which optical axes of the cylindrical lens and the condenser lens that are held by two respective lens barrels can be accurately coincided with each other, and performance may not be degraded due to displacement between the optical axes.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective diagram illustrating a light source unit in Embodiment 1 of the present invention;

FIG. 2 is a lateral section diagram illustrating the light source unit in Embodiment 1 of the present invention;

FIG. 3 is a longitudinal section diagram illustrating the light source unit in Embodiment 1 of the present invention;

FIG. 4 is a lateral section diagram illustrating a lens unit that holds cylindrical lenses of the light source unit in Embodiment 1 of the present invention;

FIG. 5 is a perspective view showing the lens unit that holds the cylindrical lenses of the light source unit in Embodiment 1 of the present invention;

FIG. 6 is a perspective view showing a lens unit that holds circular lenses of the light source unit in Embodiment 1 of the present invention, where part of the unit is taken to show the cross section;

FIG. 7 is a longitudinal section diagram showing the lens unit that holds the circular lenses of the light source unit in Embodiment 1 of the present invention;

FIG. 8 is a perspective view showing a state in which the lens unit holding the cylindrical lenses and the lens unit holding the circular lenses are coupled with each other in the light source unit in Embodiment 1 of the present invention;

FIG. 9 is a perspective diagram for explaining a positioning method of the lens unit holding the cylindrical lenses and the lens unit holding the circular lenses in the light source unit in Embodiment 1 of the present invention;

FIG. 10 is a perspective diagram for explaining another positioning method of a lens unit holding the cylindrical lenses and a lens unit holding the circular lenses in the light source unit in Embodiment 1 of the present invention;

FIG. 11 is a perspective diagram for explaining an adjustment method of an optical fiber holder in the light source unit in Embodiment 1 of the present invention;

FIG. 12 is a partially cross-sectional view of a lens-barrel portion for explaining a configuration of a light sensor unit in the light source unit in Embodiment 1 of the present invention; and

FIG. 13 is a diagram illustrating a configuration of a projection displaying apparatus 500 using light source units according to Embodiment 1 of the present invention.

### DETAILED DESCRIPTION OF THE PREFERRED EMBODIMENTS

### Embodiment 1

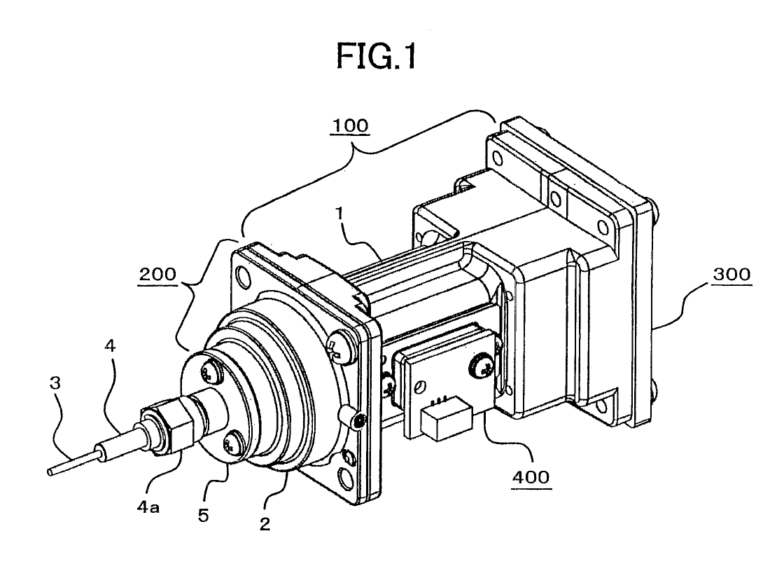

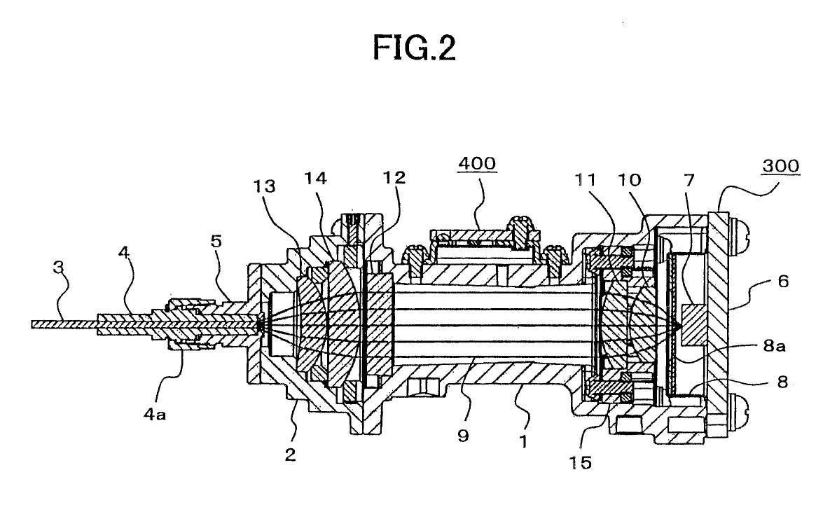

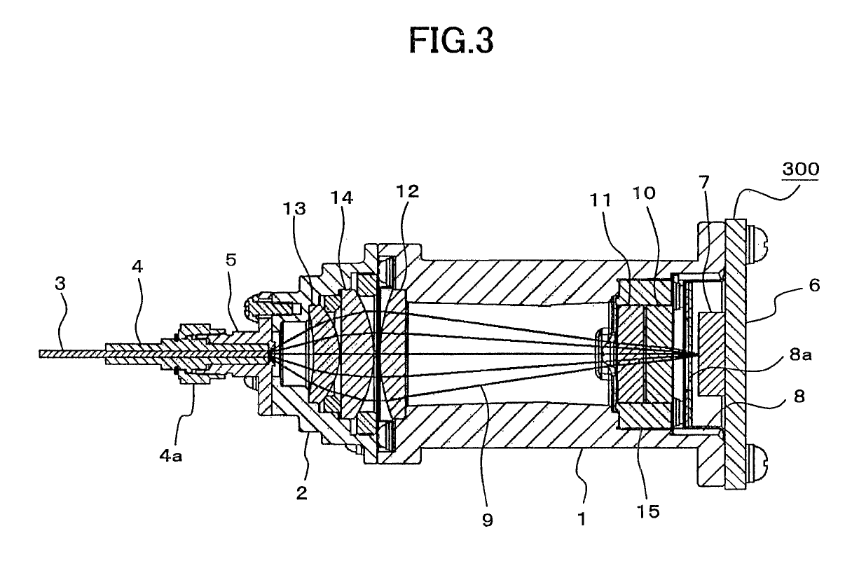

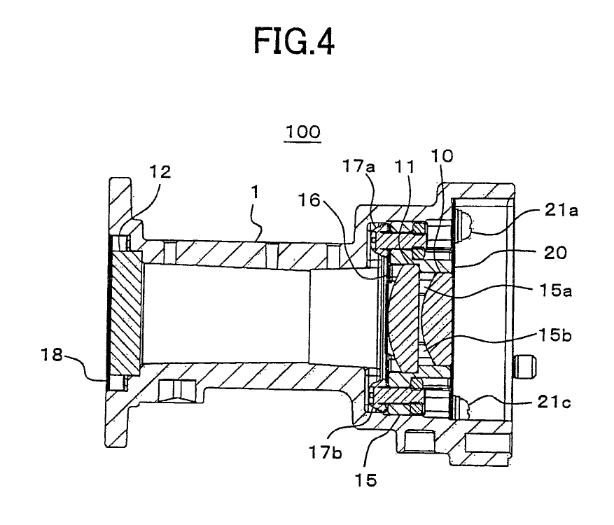

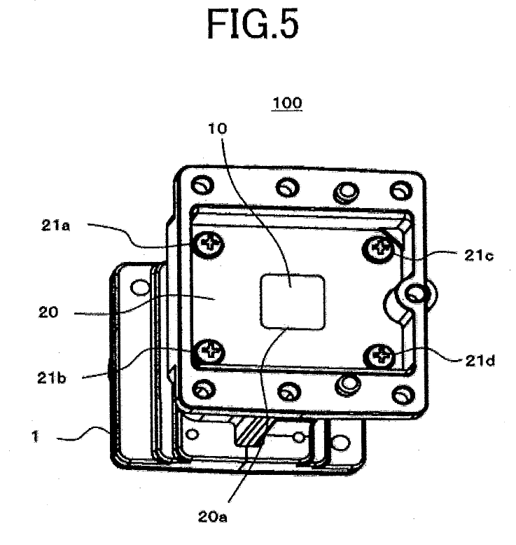

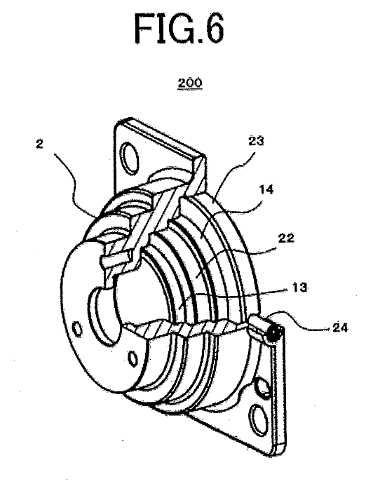

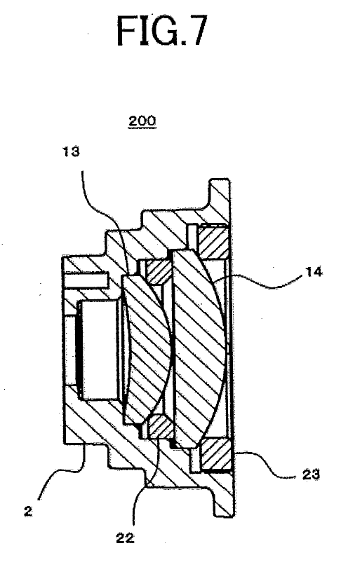

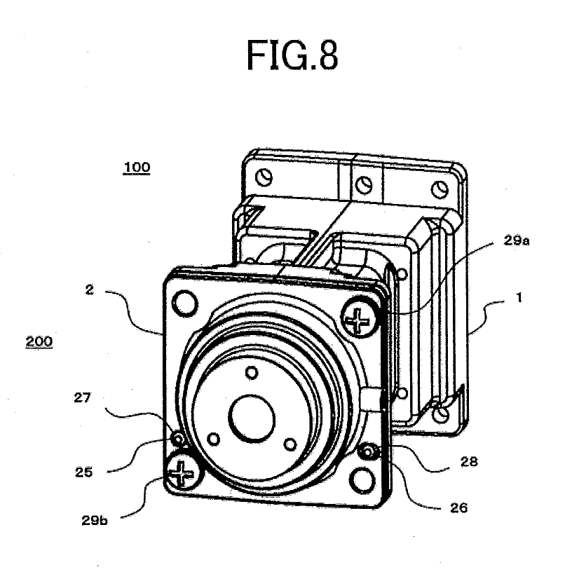

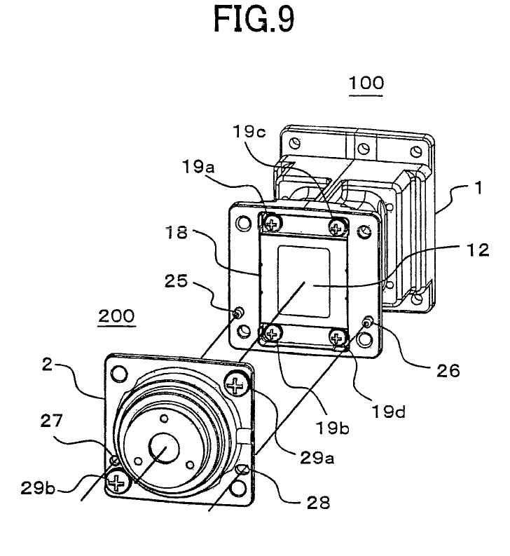

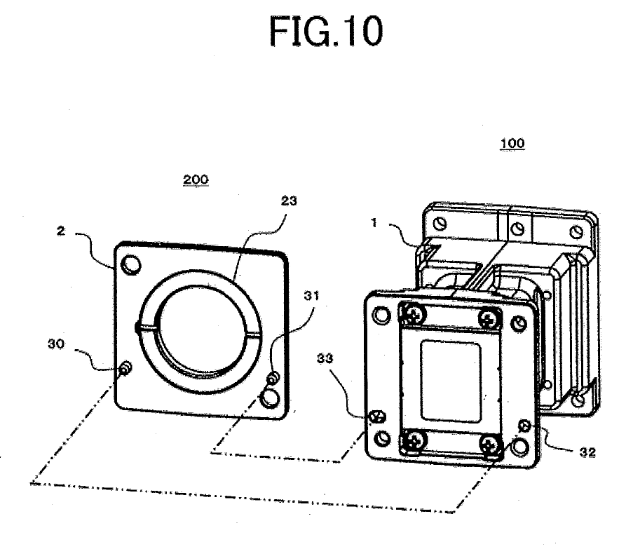

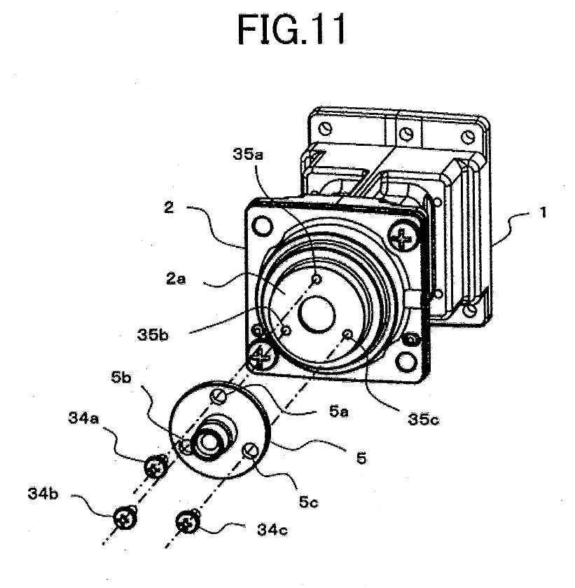

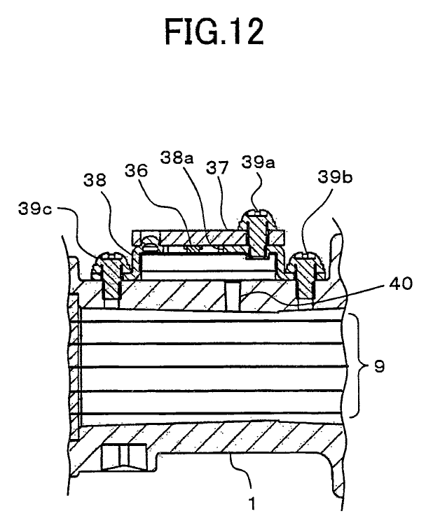

Hereunder, a light source unit according to Embodiment 1 of the present invention will be described in detail with reference to the accompanying drawings. FIG. 1 is a perspective view of the light source unit according to the embodiment; FIG. 2, a cross-sectional or lateral section diagram of the unit; FIG. 3, a longitudinal section diagram of the unit; FIG. 4, a lateral section diagram of a lens unit 100 that holds cylindrical lenses; FIG. 5, a perspective view showing the lens unit 100 viewed from behind it, which holds the cylindrical lenses; FIG. 6, a perspective view of a lens unit 200 that holds round or circular lenses (only a lens barrel part is taken to show the cross section); FIG. 7, a longitudinal section diagram of the lens unit 200 that holds the circular lenses; FIG. 8, a perspective view when the lens unit 100 that holds the cylindrical lenses and the lens unit 200 that holds the circular lenses are coupled with each other; FIG. 9 and FIG. 10, perspective diagrams for explaining positioning methods between the lens unit 100 that holds the cylindrical lenses and the lens unit 200 that holds the circular lenses; FIG. 11, a perspective diagram for explaining an adjustment method of an optical fiber holder 5; and FIG. 12, a partially cross-sectional view of a lens-barrel portion for explaining a configuration of a light sensor unit 400.

As shown in FIG. 1, the light source unit in Embodiment 1 is constituted of the lens unit 100 having a first lens barrel 1 that holds the cylindrical lenses, the lens unit 200 having the second lens barrel 2 that holds the circular lenses, the optical fiber holder 5 for fixing by a cap nut 4a a connector 4 that holds an optical fiber 3, a laser module 300 mounted at the rear end of the first lens barrel 1 for emitting a laser beam, and the light sensor unit 400 mounted on a lateral side of the first lens barrel 1 for detecting the laser beam.

As shown in FIG. 2 and FIG. 3, the laser module 300 is constituted of a base plate 6, a laser element 7 mounted thereon and a cap 8 mounted on the base plate 6 to seal the laser element 7, and is mounted being regularly positioned at the rear end of the first lens barrel 1. In the first lens barrel 1, three pieces of the cylindrical lenses 10, 11 and 12 are held. The cylindrical lens 10 and the cylindrical lens 11 are set having their generating lines or generatrices common in the same orientation, and are held in the first lens barrel 1 by way of a lens holder 15. In addition, the cylindrical lens 12 is held to have its generatrix perpendicular to the generatrices of the cylindrical lenses 10 and 11.

In the second lens barrel 2, two pieces of round or circular lenses 13 and 14 are held. The second lens barrel 2 is regularly positioned and mounted with respect to the first lens barrel 1 so that optical axes of the circular lenses 13 and 14 coincide with those of the cylindrical lenses 10, 11 and 12. Note that, in Embodiment 1, an example is described in which three pieces of the cylindrical lenses are held in the first lens barrel 1, and two pieces of the circular lenses are held in the second lens barrel 2; however, the number of each of the lenses may be changed depending on the constraining conditions such as required performance, and costs or size. In addition, in Embodiment 1, the cylindrical lenses 10 and 11 are placed in the lens holder 15, which is held by the first lens barrel 1; however, in a case in which one cylindrical lens is used, which may be directly held by a lens barrel, i.e. without intervening the lens holder, like the state of the cylindrical lens 12.

The optical fiber 3 is inserted into the connector 4 so that the front end of the fiber on the side of the second lens barrel 2 coincides with the front end of the connector 4, and is fixed to the connector 4 by adhesive or the like. In addition, on the front end, i.e., on the exit side of the second lens barrel 2, the optical fiber holder 5 is mounted. Into the optical fiber holder 5, the front end of the connector 4 is inserted, which is fixed by the cap nut 4a. At this time, the front end of the connector 4 is stopped by touching at the bottom in a hole of the optical fiber holder 5, so that positioning of the front end of the optical fiber 3 is achieved in the axial direction thereof (in depth) with respect to the optical fiber holder 5. Note that, the optical fiber 3 shown in FIG. 1 through FIG. 3 indicates a state being cut partway for explanatory purposes; however, it is a general practice that the optical fiber is actually long with desired length and is also coated with covering material.

Next, the operations of the light source unit will be explained. A laser beam 9 is emitted from the laser element 7. The laser element 7 emits the laser beam 9 whose light-rays spread in lateral directions to a large extent as shown in FIG. 2 that is a lateral section diagram, and also spread in longitudinal directions to a small extent as shown in FIG. 3 that is a longitudinal section diagram. Next, the laser beam 9 emitted from the laser element 7 passes through a glass window 8a provided in the cap 8, and is made incident to the cylindrical lens 10. As shown in FIG. 2, the laser beam 9 made incident to the cylindrical lens 10 is refracted by the cylindrical lenses 10 and 11, so that the spread in the lateral directions is compensated, resulting in a parallel-ray laser beam. On the other hand, the cylindrical lenses 10 and 11 each do not have the curvature in longitudinal directions, so that, as shown in FIG. 3, light-rays of the laser beam 9 in the longitudinal directions hardly change their angles, i.e., pass through the cylindrical lenses 10 and 11.

The laser beam 9 that propagates through a hollow within the first lens barrel 1 is made incident to the cylindrical lens 12. The cylindrical lens 12 is placed to have its generating line or generatrix perpendicular to the generatrices of the cylindrical lenses 10 and 11, so that light-rays of the laser beam 9 that spread in lateral directions do not turn as shown in FIG. 2, and light-rays of the laser beam 9 that spread in longitudinal directions are refracted to be compensated in the longitudinal directions as shown in FIG. 3, resulting in a parallel-ray laser beam. According to the operations described above, the laser beam 9 emitted from the exit side of the cylindrical lens 12 is formed into the longitudinally and laterally parallel-ray laser beam.

Subsequently, the longitudinally and laterally parallel laser beam 9 incident to the circular lens 14 is refracted in longitudinal direction and lateral direction by the circular lens 14 and the circular lens 13, and is focused onto an entrance of the optical fiber 3. The laser beam 9 being incident to the optical fiber 3 is propagated within the optical fiber 3 so as to be transferred. As described above, the laser beam 9 emitted from the laser element 7, having different divergence angles in longitudinal direction and lateral direction, is formed into a longitudinally and laterally parallel-ray beam by a plurality of such cylindrical lenses 10 and 11, and 12 that are placed to have their respective generatrices perpendicular to one another, so that the laser beam can be easily focused onto the front end of the optical fiber 3 by subsequently focusing the parallel-ray beam using the circular lenses 13 and 14.

Next, configurations of each of the lens units will be explained. In the lens unit 100 shown in FIG. 4, the cylindrical lens 10 and the cylindrical lens 11 are placed in the lens holder 15, and are held on the entrance side of the first lens barrel 1 to which the laser beam 9 is made incident. On the other hand, the cylindrical lens 12 is held on the exit side of the first lens barrel 1 from which the laser beam 9 is emitted. In addition, the cylindrical lens 11 is pressed by a plate spring 16 toward protrusions 15a and 15b provided inside the lens holder 15, and is securely held without looseness and excess play. The plate spring 16 is fastened onto the lens holder 15 by screws 17a and 17b.

The cylindrical lens 12 is directly fitted in the first lens barrel 1, and is fixed being spring-biased toward the lens-barrel side by a plate spring 18. The plate spring 18 is fastened onto the first lens barrel 1 by four pieces of screws 19a through 19d shown in FIG. 9. In addition, the cylindrical lens 12 is placed to have its generatrix perpendicular to the generatrices of the cylindrical lenses 10 and 11. This is because the spread of the laser beam 9 in lateral directions is collimated by the cylindrical lenses 10 and 11, and the spread of the laser beam 9 in longitudinal directions is collimated by the cylindrical lens 12, so that the laser beam 9 is formed into a parallel-ray laser beam.

The cylindrical lens 10 is placed in the lens holder 15 from the opposite side to the cylindrical lens 11, and is made contact with the protrusions 15a and 15b from the incident side of the laser beam 9, so that positioning in optical axis directions is achieved. And then, the cylindrical lens 10 is held, as shown in FIG. 5, by fixing a plate spring 20 from the entrance side of the first lens barrel 1 using four pieces of screws 21a through 21d. The cylindrical lens 10 is positioned as its planar side face being positioned beyond to some extent from an end-face of the lens holder 15, and is thus securely held without looseness and excess play by spring-biasing by means of the plate spring 20. Moreover, in the plate spring 20, a window 20a is provided so that the laser beam 9 passes therethrough.

As described above, the cylindrical lenses 10 and 11, and 12 are held in proximities to the respective entrance and exit sides of the first lens barrel 1, so that the first lens barrel 1 can be made as a single component in a tubular shape, and it is not only possible to reduce the number of components, but also easy to secure positional accuracy among a plurality of lenses. Moreover, the stiffness of the lens barrel can be enhanced, so that it becomes possible to reduce the thickness of material and also to lower costs.

An assembling method of the lens unit 200 will be explained using FIG. 6 and FIG. 7. First, the circular lens 13 is inserted into the second lens barrel 2, and next, a doughnut-shaped spacer 22a is inserted thereinto. Subsequently, the circular lens 14 is inserted and then fixed by a screw-thread ring 23 that is externally threaded. Under actual circumstances, the exit side of the second lens barrel 2 is lowered, and each of the components is built up by a drop-in technique. And then, the second lens barrel 2 is finally fastened from the circumferentially lateral side by a setscrew 24, so that the screw-thread ring 23 is prevented from loosening due to vibrations or the like.

As described above, the cylindrical lenses 10 through 12, and the circular lenses 13 and 14 are held by the separate lens barrels, so that it becomes possible to adopt the shape of the lens barrels that are individually made suitable for the cylindrical lenses 10 through 12, and the circular lenses 13 and 14. As for a lens barrel that holds the circular lenses, a lens barrel whose cross-section is circular can be used, and thus cylindrical machining is possible to apply using a lathe during additional machining such as on the inner surface, so that machining accuracy can be made high, a machining time can be also shortened, and costs can be reduced as well. In addition, when a lens barrel in a circular cross-section is used, it is easy to secure optical axes of the lenses, and at the time of assembling, each of the components can be assembled by a drop-in technique, so that assembling is easy, the assembly time can be shortened, and assembly costs can be reduced.

In addition, because the lens barrel that holds the cylindrical lenses can have a shape of rectangular cross-section and be made to adopt the shape suitable for an external shape of the cylindrical lenses, material thickness can be made uniform, and the material can be efficiently used. When cylindrical lenses and circular lenses are used in combination, a lens barrel takes a complex shape, and thus it is hard to form the lens barrel and also to additionally machine it; therefore, it is difficult to secure machining accuracy, resulting in rising costs.

In addition, the laser beam 9 emitted from the laser element 7 having different divergence angles in longitudinal direction and lateral direction is refracted by the cylindrical lenses 10 and 11, and 12 so as to from the beam into a longitudinally and laterally parallel-ray laser beam, so that it is possible to focus the laser beam 9 that has passed through the cylindrical lenses 10 and 11, and 12 by using the circular lenses 13 and 14. Thus, focusing a smaller spot diameter can be achieved when the laser beam 9 is focused by the circular lenses 13 and 14.

Moreover, the laser beam 9 emitted from the laser element 7 having different divergence angles in longitudinal direction and lateral direction is formed into a parallel-ray laser beam by the cylindrical lenses 10 and 11, and 12, and therefore, displacement occurred between the two lens barrels in direction parallel to their optical axes may provides a little influence. Namely even if the second lens barrel is shifted from the first lens barrel in the direction to depart therefrom, the laser beam 9 is a parallel-ray laser beam, so that it is possible to focus the laser beam 9 onto the incident end-face of the optical fiber 3 by means of the circular lenses 13 and 14.

Next, a positioning method of the first lens barrel 1 and the second lens barrel 2 will be explained. In FIGS. 8 and 9, FIG. 8 illustrates a state after the assembly, and FIG. 9, a state before the assembly. In FIG. 9, two pieces of positioning bosses 25 and 26 are provided on the exit end-face of the first lens barrel 1. On an entrance end-face of the second lens barrel 2, a positioning hole 27 and a positioning oblong hole 28 are provided at the positions opposing to the positioning bosses 25 and 26 of the first lens barrel 1, and both optical axes of the lens unit 100 and the lens unit 200 indicated by alternate long and short dashed lines in the figure are positioned so as to coincide with each other. After having the lens units 100 and 200 coupled, they are fixed by two pieces of screws 29a and 29b.

FIG. 10 illustrates a different exemplary embodiment from that in FIG. 8 and FIG. 9. In FIG. 10, such positioning bosses and a positioning hole are provided for the lens units in reversed relation to that in FIG. 8 and FIG. 9, that is, on the entrance end-face of the second lens barrel 2, the two positioning bosses 30 and 31 are provided, and on the entrance end-face of the first lens barrel 1, the positioning hole 32 and a positioning oblong hole 33 are provided at the positions opposing to the positioning bosses 30 and 31 of the second lens barrel 2. Positioning is performed by fitting the positioning boss 30 and the positioning hole 32, and the positioning boss 31 and the positioning oblong hole 33, respectively.

In each cases of FIG. 8 and FIG. 9, and of FIG. 10, the positioning bosses, the positioning holes and the oblong holes are each provided at a position apart from a midline of respective lens-barrel end-faces, whereby the orientation of the second lens barrel 2 is uniquely determined with respect to the first lens barrel 1. If at all positioning is made on the midline, the second lens barrel 2 can be assembled even when it is upside down, resulting in not uniquely determining the orientation.

In addition, the first lens barrel 1 and the second lens barrel 2 are regularly positioned and directly coupled with each other, so that it is possible to accurately make optical axes of the cylindrical lenses 10 through 12 held by the first lens barrel 1, and those of the circular lenses 13 and 14 held by the second lens barrel 2 coincide with each other. Therefore, performance may not be degraded due to displacement between the optical axes. Moreover, as in Embodiment 1, when the lenses are held at positions near to respective lens-barrel end-faces, and positioning is thus difficult using the outer circumference and the inner circumference of the lens barrels, the positioning method according to Embodiment 1 is effective.

A mounting method of the optical fiber holder 5 and a position adjustment method of the optical fiber 3 will be explained referring to FIG. 11. The optical fiber holder 5 is fastened on an exit surface 2a of the second lens barrel 2 by three pieces of screws 34a through 34c. The exit surface 2a of the second lens barrel 2 is planar, and further female screw-threads 35a through 35c are cut therein at the segment angle of 120 degrees therebetween. The optical fiber holder 5 is attached on such an exit surface, and the screws 34a through 34c are loosely secured. Next, the connector 4 is plugged into the optical fiber holder 5 so as to be fixed. Note that, the position adjustment of the optical fiber 3 is performed in a state in which the laser module 300 shown in FIG. 1 through FIG. 3 is mounted and the laser beam 9 is emitted to an incident end of the optical fiber holder 5.

The screws 34a through 34c having been tentatively secured are loosened, so that the optical fiber holder 5 is allowed movable in the plane of the surface. The optical fiber holder 5 can be moved by the amount of looseness and play of holes 5a through 5c drilled in the planar bottom portion, and the screws 34a through 34c. As shown in FIGS. 2 and 3, the laser beam 9 is focused onto the point at which the optical fiber 3 should be positioned normally, so that, by moving the optical fiber holder 5 in the plane of the surface, it is possible to make the incident end-face of the optical fiber 3 coincide with the focusing point of the laser beam 9. The determination whether or not the front end of the optical fiber 3 coincides with the focusing point is carried out by measuring intensity of the laser beam 9 outputted from the exit of the optical fiber 3, that is, at the position where the intensity is maximized, the optical fiber holder 5 is fixed by tightly fastening the screws 34a through 34c.

The optical fiber holder 5 is movably held in the plane of the surface, i.e., on the exit surface 2a of the second lens barrel 2 by the amount of looseness and play of the holes 5a through 5c and the screws 34a through 34c, so that a complex adjustment mechanism is not required, and the number of components can be reduced. Therefore, a position adjustment mechanism for the optical fiber 3 is realized with lower costs and higher reliability. In addition, the position adjustment of the optical fiber 3 is performed by sliding, with respect to the exit surface 2a, the optical fiber holder 5 on which the optical fiber 3 is mounted by way of the connector 4, and therefore, the position adjustment of the optical fiber 3 is proceeded without deviating the incident end-face of the optical fiber 3 in optical axis directions, and highly precise positioning is made possible.

Shown in FIG. 12 is an enlarged view of the light sensor unit 400 shown in FIG. 2, where a light sensor 36 is mounted on a board 37, and the board 37 is fixed on a board holder 38 by a screw 39a.

In the board holder 38, a window 38a is provide so as to accommodate the light sensor 36, and the board 37 is fixed to a lateral side of the first lens barrel 1 by two pieces of screws 39b and 39c, with the mounting face of the board for the light sensor 36 facing down. In addition, the board holder 38 has a bathtub-shaped structure so that the light sensor 36 is not brought close contact with the lateral side of the first lens barrel 1, and is held to provide an interspace to the first lens barrel 1. Meanwhile, a light detection hole 40 is provided on the lateral side of the first lens barrel 1, so that, part of the laser beam 9 is introduced into the board holder 38 through the hole.

The hole 40 provided in the first lens barrel 1 is placed off the light path of the laser beam 9, that is, at the position where the laser beam 9 does not directly enter into the hole 40, so that scattered light that is reflected diffusely in the first lens barrel 1 is introduced into the hole. If intensity of the laser beam 9 incident to the light sensor 36 is too high, the light sensor 36 becomes functionally saturated, so that the intensity of the beam cannot be detected. For this reason, in addition to make the hole 40 in an appropriate size, the light sensor 36 is placed off, and slightly shifted, the axis line of the hole 40, whereby part of the laser beam 9 to be detected is reflected and attenuated in the board holder 38. In order to further attenuate the part of the laser beam 9, the inner surface of the board holder 38 may be roughened or colored in black.

According to the configuration in which the hole 40 provided in the first lens barrel 1 to introduce part of the laser beam 9 is placed at the position where the laser beam 9 does not directly enter, the light sensor 36 is placed at a position apart slightly from the axis line of the hole 40; and then, a shape of the board holder 38 is designed so that the part of the laser beam 9 is internally reflected and attenuated, and the inner surface of the board holder 38 may be roughened or colored in black, therefore light intensity detection can be stably carried out even when the intensity of the laser beam 9 is strong. In addition, because intensity of the laser beam 9 is detected by the light sensor 36, and changes in the intensity of the laser beam are monitored, it is possible to determine an unexpected malfunction of the laser element 7 or its operating life. Moreover, when the detected intensity is compared with that of the output of the exit side of the optical fiber 3, it is also possible to detect a disconnection in the optical fiber 3, reduction of transmissivity therein, or the like.

### Embodiment 2

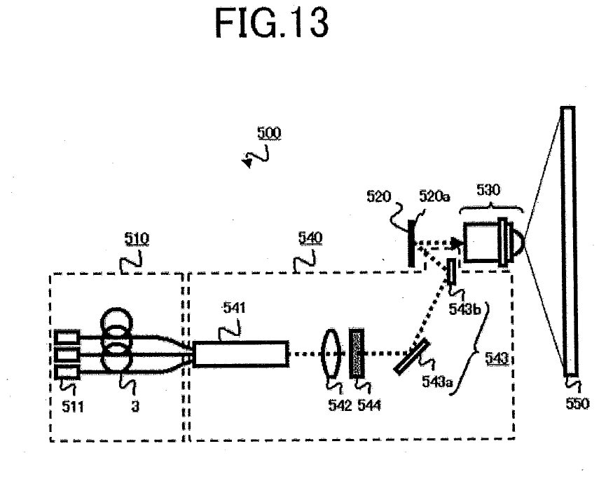

FIG. 13 is a diagram illustrating a configuration of a projection displaying apparatus 500 as an image displaying apparatus using light source units according to Embodiment 1 of the present invention. The projection displaying apparatus 500 is a rear projection television that projects images onto a screen using a light valve.

As shown in FIG. 13, the projection displaying apparatus 500 according to Embodiment 2 includes a condensing optical system 510, an illumination optical system 540, a reflection-type light modulation device (reflection-type light valve) 520 as an image displaying device, and a projection optical system 530 that enlarges and projects onto the transmission-type screen 550 images on an illumination surface (image producing area) 520a of the reflection-type light modulation device 520 which is illuminated by the illumination optical system 540.

The condensing optical system 510 is constituted of light source units 511 having a plurality of colors (three colors in FIG. 13) and a plurality of pieces (three pieces in FIG. 13) of such optical fibers 3 that guide light beams emitted from the light source units 511 into the illumination optical system 540. Among the light source units 511 having the plurality of colors, at least one is the light source unit according to Embodiment 1.

In the condensing optical system 510, laser beams emitted from the light source units 511 are guided into the illumination optical system 540 by way of the optical fibers 3 corresponding to the light source units 511.

The illumination optical system 540 includes a light intensity uniformizing device 541 that uniformly distributes the intensity of laser beams emitted from the condensing optical system 510 (optical fibers 3), a relay-lens group 542, a diffusion device 544, and a mirror group 543 constituted of a first mirror 543a and a second mirror 543b. The illumination optical system 540 thus guides by means of the relay-lens group 542 and the mirror group 543 a light beam emitted from the light intensity uniformizing device 541 onto the reflection-type light modulation device 520.

The light intensity uniformizing device 541 has a function to uniformize the light intensity of the laser beams (for example, a function to reduce inconsistencies of illuminance) emitted from the condensing optical system 510. The light intensity uniformizing device 541 is disposed in the illumination optical system 540 so that an incident face (incident end-face) that is an entrance of incident light is set facing toward the optical fibers 3, and an emission face (emission end-face) that is a light emission exit is set facing toward the relay-lens group 542.

The light intensity uniformizing device 541 is made of a transparent material, for example, glass, resin or the like. The light intensity uniformizing device 541 includes a polygonally columned rod (columned member having its cross-sectional shape polygonal) whose sidewall has an internal surface of total reflection, or a polygonal pipe (tubular member) having inwardly arranged light reflection surfaces tubularly combined with its cross-sectional shape polygonal.

When the light intensity uniformizing device 541 is a polygonally columned rod, light is emitted from an emission end (emission exit) after having light reflected a number of times by utilizing a total reflection action on an interface between a transparent material and air.

When the light intensity uniformizing device 541 is a polygonal pipe, light is emitted from the emission exit after having light reflected a number of times by utilizing a reflection action by the surface mirror inwardly facing.

When an appropriate length is secured for the light intensity uniformizing device 541 in the traveling direction of the light beam, the light internally reflected a number of times is superimposed and emitted in proximity to the emission face of the light intensity uniformizing device 541; therefore, a substantially uniform intensity distribution can be obtained in the proximity to the emission face of the light intensity uniformizing device 541. Light emitted from the emission face having the substantially uniform intensity distribution is guided by the relay-lens group 542 and the mirror group 543 onto the reflection-type light modulation device 520, so that the illumination surface 520a of the reflection-type light modulation device 520 is illuminated.

In addition, in the illumination optical system 540, the diffusion device (diffusing portion) 544 is provided downstream of the relay-lens group 542. The diffusion device 544 is a device that reduces speckle by diffusing the light propagated by way of the relay-lens group 542 and then by sending it to the mirror group 543. The diffusion device 544 is a holographic diffusion device or the like that can specify light diffusion angles using a hologram pattern provided on the substrate, and that mitigates coherency attributed to the light source units 511.

In addition, by rotating, moving or vibrating the diffusion device 544, or doing the like, the coherency attributed to the light source units 511 can be effectively mitigated.

The reflection-type light modulation device 520 is, for example, a light modulation device of a reflection-type such as a digital micromirror device (DMD). The reflection-type light modulation device 520 is configured in such a manner that a large number of movable micromirrors corresponding to pixels each (for example, hundreds of thousands of pieces) are arranged in a planar surface, and a slope angle (tilt) of each of the micromirrors is changed depending on pixel information.

The projection optical system 530 enlarges and projects onto a transmission-type screen 550 images on the illumination surface (image producing area) 520a of the reflection-type light modulation device 520. According to this arrangement, the images are displayed on the transmission-type screen 550.

Note that, shown in FIG. 13 is a case in which the relay-lens group 542 is configured by one lens; however, the lens number is not limited to one, and a plurality of lenses may be used. Likewise, as for the mirror group 543, the mirrors are not limited to two, and the mirror group 543 may be configured by one, or by three or more mirrors.

Note that in FIG. 13, laser beams emitted from the light source units 511 having a plurality of colors are guided into the illumination optical system 540 by way of the optical fibers 3 corresponding to the respective light source units 511; however, laser beams emitted from the light source units 511 may be combined using a dichroic mirror or the like, and then be incident to the illumination optical system 540.

While the present invention has been shown and described in detail, the foregoing description is in all aspects illustrative and not restrictive. It is therefore understood that numerous modifications and variations can be realized without departing from the scope of the invention.

### EXPLANATION OF NUMERALS AND SYMBOLS

“1” designates a first lens barrel; “2,” second lens barrel; “2a,” exit surface; “3,” optical fiber; “5,” optical fiber holder; “7,” laser element; “9,” laser beam; “10,” “11,” “12,” cylindrical lens; “13,” “14,” circular lens; “25,”

26,” positioning boss; “27,” positioning hole; “28,” oblong hole; “30,” “31,” positioning boss; “32,” positioning hole; “33,” oblong hole; “36,” light sensor; “37,” board; “38,” board holder; “40,” hole; “100,” lens unit; “200,” lens unit; “300,” laser module; and “400,” light sensor unit.

1. A light source unit, comprising:
a laser element for emitting a laser beam having different divergence angles in longitudinal direction and lateral direction;
at least one cylindrical lens placed with its generatrix perpendicular to an optical axis of the laser beam for forming the laser beam into a parallel-ray laser beam;
a first lens barrel for holding the at least one cylindrical lens;
a condenser lens placed downstream of the at least one cylindrical lens for focusing the parallel-ray laser beam; and
a second lens barrel for holding the condenser lens; wherein
the first lens barrel and the second lens barrel are positioned and coupled with each other so that an optical axis of the at least one cylindrical lens coincides with an optical axis of the condenser lens.

2. The light source unit as set forth in claim 1, wherein the condenser lens focuses the parallel-ray laser beam onto an entrance of an optical fiber placed downstream of the condenser lens.

3. The light source unit as set forth in claim 1, wherein the condenser lens focuses the parallel-ray laser beam onto an entrance of a light intensity uniformizing device placed downstream of the condenser lens.

4. The light source unit as set forth in claim 1, wherein
the at least one cylindrical lens includes a first cylindrical lens for collimating laser beam rays in a plane in which the beam has a larger divergence angle and a second cylindrical lens for collimating laser beam rays in a plane in which the beam has a smaller divergence angle; and
the first cylindrical lens is held on an entrance side of the first lens barrel and, on an exit side thereof, the second cylindrical lens is held so that a generatrix thereof is made perpendicular to a generatrix of the first cylindrical lens.

5. The light source unit as set forth in claim 1, wherein the first lens barrel comprises an engaging portion, the second lens barrel comprises a portion to be engaged with the engaging portion, the portion to be engaged serving to ensure positioning of the first lens barrel and the second lens barrel so that the optical axis of the at least one cylindrical lens coincides with the optical axis of the condenser lens.

6. The light source unit as set forth in claim 1, wherein
two positioning bosses are provided on an exit end-face of the first lens barrel at their respective positions distant from a midline of the exit end-face, and
on an entrance end-face of the second lens barrel, a positioning hole that fits with one of the positioning bosses, and an oblong hole that fits with the other one are provided.

7. The light source unit as set forth in claim 1, wherein
two positioning bosses are provided on an entrance end-face of the second lens barrel at their respective positions distant from a midline of the entrance end-face, and
on an exit end-face of the first lens barrel, a positioning hole that fits with one of the positioning bosses, and an oblong hole that fits with the other one are provided.

8. The light source unit as set forth in claim 1, wherein on an exit surface of the second lens barrel, an optical fiber holder is held movably in a plane of the surface.

9. The light source unit as set forth in claim 1, further comprising:
a light detection hole provided on a side of the first lens barrel at a position that is not directly struck by the laser beam, and
a light sensor provided outside the first lens barrel; wherein
light intensity of the laser beam is detected, using the light sensor, by detecting scattered light rays of the laser beam leaking from the light detection hole.

10. The light source unit as set forth in claim 9, wherein the light sensor is held at a position apart from the axis line of the light detection hole.

11. An image displaying apparatus including an image displaying device for producing, on its illumination area being illuminated, an image to be displayed on a screen, comprising:
a light source unit as set forth in claim 1;
an illumination optical system for illuminating the image displaying device by a laser beam emitted from the light source unit; and
a projection optical system for enlarging and projecting the image produced on the image displaying device onto the screen.

12. The light source unit as set forth in claim 3, wherein
the at least one cylindrical lens includes a first cylindrical lens for collimating laser beam rays in a plane in which the beam has a larger divergence angle and a second cylindrical lens for collimating laser beam rays in a plane in which the beam has a smaller divergence angle; and
the first cylindrical lens is held on an entrance side of the first lens barrel and, on an exit side thereof, the second cylindrical lens is held so that a generatrix thereof is made perpendicular to a generatrix of the first cylindrical lens.

13. The light source unit as set forth in claim 5, wherein
the engaging portion includes two positioning bosses which are provided on an exit end-face of the first lens barrel at their respective positions distant from a midline of the exit end-face, and
the portion to be engaged includes a positioning hole that fits with one of the positioning bosses, which are provided on an entrance end-face of the second lens barrel, and an oblong hole that fits with the other one, which are provided on an entrance end-face of the second lens barrel.

14. The light source unit as set forth in claim 5, wherein
the portion to be engaged includes two positioning bosses which are provided on an entrance end-face of the second lens barrel at their respective positions distant from a midline of the entrance end-face, and
the engaging portion includes a positioning hole that fits with one of the positioning bosses, which are provided on an exit end-face of the first lens barrel, and an oblong hole that fits with the other one, which are provided on the exit end-face of the first lens barrel.
